(19) United States
(12) Patent Application Publication
(10) Pub. No.: US 2026/0218753 A1
(43) Pub. Date: Jul. 30, 2026

(54) SLIDING MEMBER AND ROLLING BEARING

(71) Applicants: JTEKT SEALING TECHNO CORPORATION, Itano-gun, Tokushima (JP); JTEKT CORPORATION, Kariya-shi, Aichi (JP)

(72) Inventors: Ikuo YAMAMOTO, Kashiwara-shi (JP); Kenji KONDO, Itano-gun (JP); Takashi HARA, Itano-gun (JP)

(73) Assignees: JTEKT SEALING TECHNO CORPORATION, Itano-gun, Tokushima (JP); JTEKT CORPORATION, Kariya-shi, Aichi (JP)

(21) Appl. No.: 19/145,809

(22) PCT Filed: Nov. 15, 2023
(86) PCT No.: PCT/JP2023/041120

§ 371 Date: Jul. 3, 2025

(30) Foreign Application Priority Data
Feb. 24, 2023 (JP) 2023-027502

(51) Int. Cl. F16C 33/78; F16C 19/06; F16C 41/00

(52) U.S. Cl. CPC F16C 33/7816; F16C 19/06; F16C 41/002; F16C 2202/32; F16C 2206/06; F16C 2208/10; F16C 2212/08

(57) ABSTRACT

A sliding member includes: a sheet that is a nonwoven fabric or a woven fabric formed of conductive fibers; a metal ring; and a rubber, wherein the sheet integrally has: a fixed portion that is fixed in a state of being in contact with a first member including a steel material on a first side in a radial direction of the metal ring; a sliding portion slidably contacting a second member including a steel material on a second side in the radial direction; and an intermediate portion positioned between the fixed portion and the sliding portion, the metal ring is disposed at an interval on a first side in an axial direction with respect to the sheet, and the rubber has a first portion disposed in the interval.

### TECHNICAL FIELD

The present disclosure relates to a sliding member and a rolling bearing.

### BACKGROUND ART

A rolling bearing having an electrolytic corrosion preventing function is disclosed in PATENT LITERATURE 1. The rolling bearing described in PATENT LITERATURE 1 is a bearing that supports a rotating shaft of an electric motor mounted on an electric vehicle or the like. This rolling bearing includes an outer ring, an inner ring, a plurality of balls disposed between the outer ring and the inner ring, and annular seals (sliding members) that each close an end opening of a bearing internal space between the outer ring and the inner ring. Each of the seals includes an elastic material such as rubber having a conductivity. An inner peripheral edge and an outer peripheral edge of this elastic material are in contact with the inner ring and the outer ring, respectively. When the elastic material comes into contact with the inner ring and the outer ring, the inner ring is electrically connected to the outer ring through the elastic material, and a current is restrained from flowing between the inner ring and the balls and between the outer ring and the balls, and electrolytic corrosion of a raceway of the inner ring, a raceway of the outer ring, and the balls are suppressed.

### Citation List

### Patent Literature

PATENT LITERATURE 1: Japanese Laid-Open Patent Publication No. 2015-102200

### SUMMARY OF THE INVENTION

### Technical Problem

The elastic material of the seal (the sliding member) in PATENT LITERATURE 1 has a certain degree of conductivity by kneading carbon fibers into the rubber. On the other hand, in order to further suppress the electrolytic corrosion of the raceways, it is required to further enhance the conductivity of the seal. Therefore, an object of the present disclosure is to enhance a conductivity of a sliding member.

### Solution to Problem

(1) A sliding member of the present disclosure includes:
a sheet that is a nonwoven fabric or a woven fabric formed of conductive fibers;
a metal ring; and
a rubber,
wherein the sheet integrally has:
   a fixed portion that is fixed in a state of being in contact with a first member including a steel material on a first side in a radial direction of the metal ring;
   a sliding portion slidably contacting a second member including a steel material on a second side in the radial direction; and
   an intermediate portion positioned between the fixed portion and the sliding portion,
the metal ring is disposed at an interval on a first side in an axial direction with respect to the sheet, and
the rubber has a first portion disposed in the interval.

(2) A rolling bearing of the present disclosure includes:
an inner ring having an inner ring raceway;
an outer ring having an outer ring raceway disposed on a radially outer side of the inner ring raceway;
a plurality of rolling elements rotatably disposed between the inner ring raceway and the outer ring raceway; and
the sliding member according to the above-described (1), the sliding member being disposed between an end portion in the axial direction of the inner ring and an end portion in the axial direction of the outer ring in the radial direction,
wherein one of the inner ring and the outer ring is the first member, and
the other of the inner ring and the outer ring is the second member.

### Advantageous Effects of the Invention

The sliding member of the present disclosure includes the sheet that is a nonwoven fabric or a woven fabric formed of conductive fibers, and this sheet can have an electrical resistance smaller than that of an elastic material obtained by kneading carbon fibers into rubber, and can enhance conductivity. Therefore, in the sliding member, the first member and the second member are electrically connected by the sheet, and a current can flow from one of the first member and the second member to the other via the sheet.

### BRIEF DESCRIPTION OF DRAWINGS

FIG. 1 is a cross-sectional view illustrating one example of a rolling bearing of the present disclosure.

FIG. 2 is an enlarged cross-sectional view of a sliding member.

FIG. 3 is an enlarged cross-sectional view of a radially outer portion of the sliding member of FIG. 2.

FIG. 4 is an enlarged cross-sectional view of a radially inner portion of the sliding member of FIG. 2.

FIG. 5 is a cross-sectional view illustrating a part of a molding die of the sliding member.

### DETAILED DESCRIPTION

### Overview of Embodiments of Invention

Hereinafter, an outline of embodiments of the present disclosure will be listed and described.

(1) A sliding member of the present disclosure includes:
a sheet that is a nonwoven fabric or a woven fabric formed of conductive fibers;
a metal ring; and
a rubber,
wherein the sheet integrally has:
   a fixed portion that is fixed in a state of being in contact with a first member including a steel material on a first side in a radial direction of the metal ring;
   a sliding portion slidably contacting a second member including a steel material on a second side in the radial direction; and
   an intermediate portion positioned between the fixed portion and the sliding portion,
the metal ring is disposed at an interval on a first side in an axial direction with respect to the sheet, and
the rubber has a first portion disposed in the interval.

According to this configuration, the sliding member includes the sheet that is a nonwoven fabric or a woven fabric formed of conductive fibers, and the sheet can have an electrical resistance smaller than that of an elastic material obtained by kneading carbon fibers into rubber, and can enhance conductivity. Therefore, in the sliding member, the first member and the second member are electrically connected by the sheet, and a current can flow from one of the first member and the second member to the other via the sheet.

(2) Preferably, in the sliding member of the above-described (1), the rubber further includes a second portion disposed on the first side in the radial direction with respect to the first portion and a third portion disposed on the second side in the radial direction with respect to the first portion, and
the first portion, the second portion, and the third portion are bonded to an entirety of the first side in the axial direction of the sheet.

With such a configuration, a shape of the entire sheet can be held by the rubber.

(3) Preferably, in the sliding member according to the above-described (1) or (2), the rubber has a fourth portion disposed beyond an end portion in the radial direction of the metal ring on the first side in the axial direction with respect to the metal ring.

With such a configuration, the bonding between the rubber and the metal ring can be strengthened. Further, since the fourth portion is disposed on the side opposite to the sheet in the axial direction, the fourth portion does not damage the sheet.

(4) A rolling bearing of the present disclosure includes:
an inner ring having an inner ring raceway;
an outer ring having an outer ring raceway disposed on a radially outer side of the inner ring raceway;
a plurality of rolling elements rotatably disposed between the inner ring raceway and the outer ring raceway; and
the sliding member according to any one of the above-described (1) to (3), the sliding member being disposed between an end portion in the axial direction of the inner ring and an end portion in the axial direction of the outer ring in the radial direction,
wherein one of the inner ring and the outer ring is the first member, and
the other of the inner ring and the outer ring is the second member.

According to this configuration, the outer ring and the inner ring of the rolling bearing can be electrically connected by the sheet of the sliding member, and a current can be caused to flow from one of the outer ring and the inner ring to the other via the sheet to suppress electrolytic corrosion of the outer ring raceway, the inner ring raceway, and the balls.

(5) Preferably, in the rolling bearing according to the above-described (4), the sheet of the sliding member is disposed closer to the rolling elements than the metal ring and the rubber in the axial direction.

With such a configuration, the sliding portion of the sliding member can be easily brought into contact with the inner ring or the outer ring.

### Details of Embodiments of Invention of Present Disclosure

Hereinafter, embodiments of the present disclosure will be described.

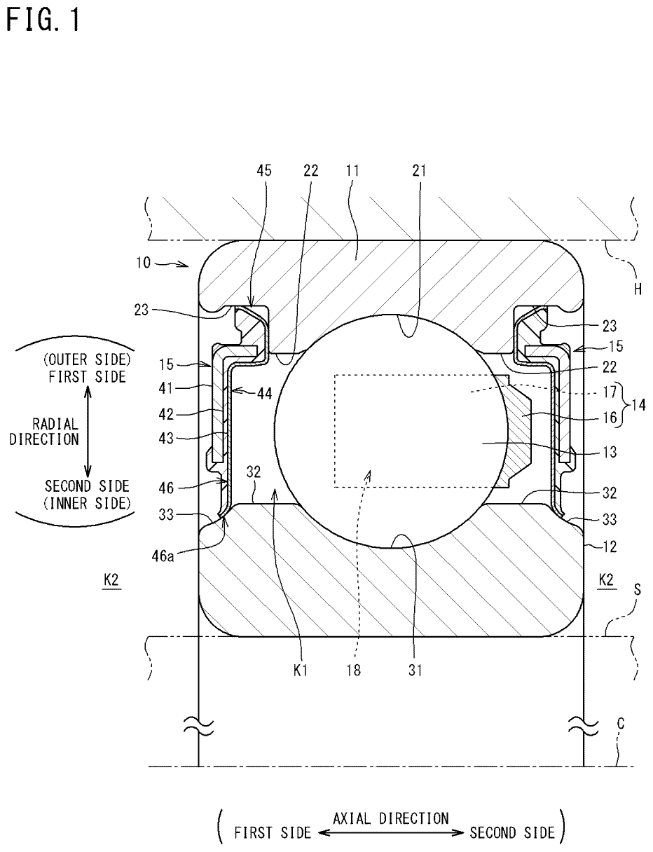

FIG. 1 is a cross-sectional view illustrating one example of a rolling bearing of the present disclosure.

A rolling bearing 10 illustrated in FIG. 1 supports a rotating shaft S of a motor mounted on, for example, an electric vehicle or a hybrid vehicle. In FIG. 1, the rotating shaft S is indicated by imaginary lines (two-dot chain lines).

The rolling bearing 10 includes an outer ring 11, an inner ring 12, a plurality of rolling elements 13, a retainer 14, and sliding members 15. In the present embodiment, the rolling elements 13 are balls. The rolling bearing 10 is a deep groove ball bearing. The outer ring 11 is attached to a housing H of the motor. The inner ring 12 is fitted in and fixed to an outer peripheral surface of the rotating shaft S. In FIG. 1, the housing H is indicated by an imaginary line (a two-dot chain line). In the present embodiment, the outer ring 11 is a fixed ring, and the inner ring 12 is a rotating ring. The outer ring 11 and the inner ring 12 are formed of a steel material such as bearing steel. As the bearing steel, high carbon chromium bearing steel (for example, SUJ2 or SUJ3 defined in JIS standard) can be employed. However, the outer ring 11 and the inner ring 12 may be other steel materials such as carburized bearing steel, carbon steel, chromium steel, and stainless steel.

The outer ring 11 and the inner ring 12 are disposed concentrically. In the present embodiment, central axes of the outer ring 11 and the inner ring 12 coincide with a central axis C of the rolling bearing 10. Further, in the present embodiment, a direction along the central axis C and a direction parallel to the central axis C are defined as an “axial direction”. Similarly, a direction orthogonal to the central axis C is defined as a “radial direction”. Similarly, a direction along a circle centered on the central axis C is defined as a “circumferential direction”. In addition, in the present embodiment, a left side in FIG. 1 is an axially first side, a right side in FIG. 1 is an axially second side, an upper side in FIG. 1 is a radially first side, and a lower side in FIG. 1 is a radially second side. In addition, in the present embodiment, the radially first side is a radially outer side, and the radially second side is a radially inner side. Therefore, in the following description, the radially first side may be referred to as the radially inner side, and the radially second side may be referred to as the radially outer side.

The outer ring 11 includes an outer ring raceway 21, two shoulders 22, and two annular grooves 23. The outer ring raceway 21 is provided on an inner peripheral surface of the outer ring 11. The balls 13 roll on this outer ring raceway 21. The two shoulders 22 are provided on both sides in the axial direction of the outer ring raceway 21. The two annular grooves 23 are each provided between each of the shoulders 22 and each side surface in the axial direction of the outer ring 11. Each of the annular grooves 23 has an annular groove shape continuous in the circumferential direction. The sliding members 15 are attached to the annular grooves 23 disposed on both sides of the outer ring 11 in the axial direction. However, the sliding member 15 may be attached only to the annular groove 23 disposed on one of the axially first side and the axially second side of the outer ring 11. In this case, the annular groove 23 to which the sliding member 15 is not attached may be omitted.

The inner ring 12 includes an inner ring raceway 31, two shoulders 32, and two sliding member contact surfaces 33. The inner ring raceway 31 is included on an outer peripheral surface of the inner ring 12. The balls 13 roll on this inner ring raceway 31. The two shoulders 32 are provided on both sides in the axial direction of the inner ring raceway 31. The two sliding member contact surfaces 33 are each provided between each of the shoulders 32 and each side surface of the inner ring 12. The sliding member contact surfaces 33 are annularly provided on an entire circumference of the inner ring 12. Each of the sliding member contact surfaces 33 has a groove shape in a cross section including the central axis C of the inner ring 12. A radially inner end portion of the sliding member 15 is in contact with the sliding member contact surface 33.

The balls 13 are disposed between the outer ring 11 and the inner ring 12. Each of the balls 13 comes into rolling contact with the outer ring raceway 21 and the inner ring raceway 31. The plurality of balls 13 are retained at intervals in the circumferential direction by the annular retainer 14.

The retainer 14 has an annular body 16 and a plurality of horns (pillars) 17. The annular body 16 is provided on the axially second side of the balls 13. The plurality of horns (pillars) 17 are provided to extend from the annular body 16 to the axially first side. A pocket 18 is a space between the two horns 17 circumferentially adjacent, the space being on the axially first side of the annular body 16. The pocket 18 accommodates the ball 13. The pocket 18 is open on the axially first side.

Each of the sliding members 15 is formed in an annular shape. The sliding member 15 is fixed to the outer ring (a first member) 11 and is in sliding contact with the inner ring (a second member) 12. Specifically, the sliding member 15 is fixed to the outer ring 11 by fitting a radially outer end portion (an end portion on the radially first side) thereof into the annular groove 23 of the outer ring 11. The radially inner end portion (the end portion on the radially second side) of the sliding member 15 is in contact with the sliding member contact surface 33 of the inner ring 12. The sliding members 15 are provided on both the sides in the axial direction of the rolling bearing 10. Therefore, a bearing internal space K1 that is an annular space between the outer ring 11 and the inner ring 12 and in which the balls 13 exist, is closed by the sliding members 15 on both the sides in the axial direction. The sliding members 15 define the bearing internal space K1 in which the balls 13 exist and a bearing external space K2 that is a space on the axially first side and the axially second side with respect to the rolling bearing 10.

Each of the sliding members 15 includes a sheet 43 having a conductivity, the sheet 43 being disposed between the radially outer end portion and the radially inner end portion. In the sliding member 15, the sheet 43 is exposed to a surface at the radially outer end portion, and is in contact with the annular groove 23 of the outer ring 11. In the sliding member 15, the sheet 43 is exposed to the surface at the radially inner end portion, and is in contact with the sliding member contact surface 33 of the inner ring 12. Therefore, the sliding member 15 constitutes an energization path for suppressing a current generated by the motor or the like from flowing between the outer ring 11 and the inner ring 12 via the rolling elements 13. Oil films made of lubricating oil or grease are formed between the balls 13 and the inner ring raceway 31 and between the balls 13 and the outer ring raceway 21. The oil films have an insulating property. Due to the insulation property of the oil films, the balls 13 and the inner ring raceway 31, and the balls 13 and the outer ring raceway 21 are insulated from each other. When the oil film is formed between the balls 13 and the inner ring raceway 31 and a potential difference equal to or less than a predetermined value is generated between the balls 13 and the inner ring raceway 31, a current does not flow between the inner ring raceway 31 and the balls 13. When the oil film is formed between the balls 13 and the outer ring raceway 21 and a potential difference equal to or less than a predetermined value is generated between the balls 13 and the outer ring raceway 21, a current does not flow between the outer ring raceway 21 and the balls 13. However, when the oil film between the balls 13 and the inner ring raceway 31 is partially broken, or when a potential difference exceeding the predetermined value occurs between the balls 13 and the inner ring raceway 31, a current flows between the balls 13 and the inner ring raceway 31, so that there is a possibility that the current causes electrolytic corrosion in the balls 13 and/or the inner ring raceway 31. When the oil film between the balls 13 and the outer ring raceway 21 is partially broken, or when a potential difference exceeding the predetermined value occurs between the balls 13 and the outer ring raceway 21, a current flows between the balls 13 and the outer ring raceway 21, so that there is a possibility that the current causes electrolytic corrosion in the balls 13 and/or the outer ring raceway 21. Since the rolling bearing 10 of the present embodiment is provided with the sliding members 15 forming the energization paths, before the potential difference between the balls 13 and the inner ring raceway 31 or the potential difference between the balls 13 and the outer ring raceway 21 increases, a potential difference between the outer ring 11 and the inner ring 12 decreases by causing a current to flow between the outer ring 11 and the inner ring 12 via the sliding members 15. As the potential difference between the outer ring 11 and the inner ring 12 decreases, the occurrence of electrolytic corrosion of the balls 13, the inner ring raceway 31, and the outer ring raceway 21 is suppressed.

### Specific Structure of Sliding Member 15

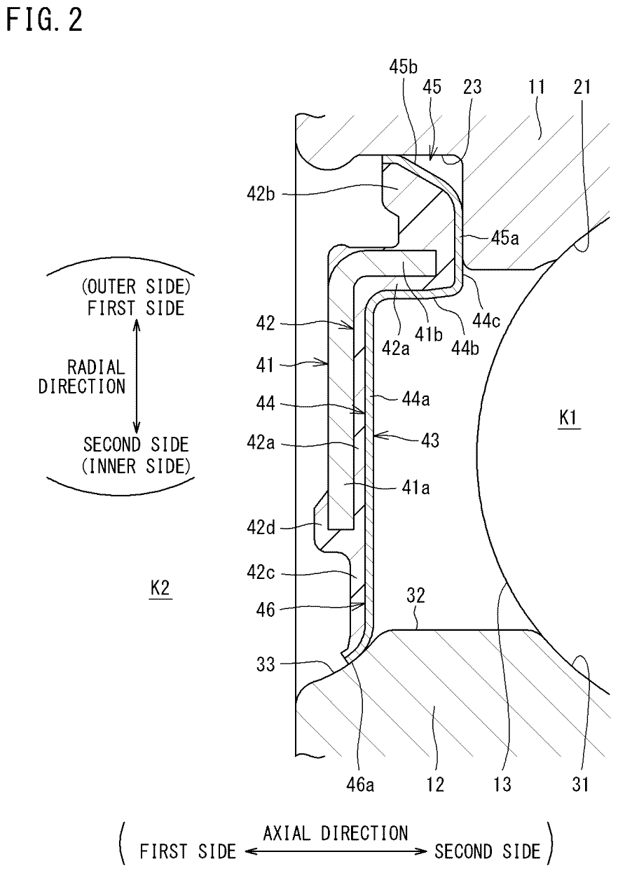

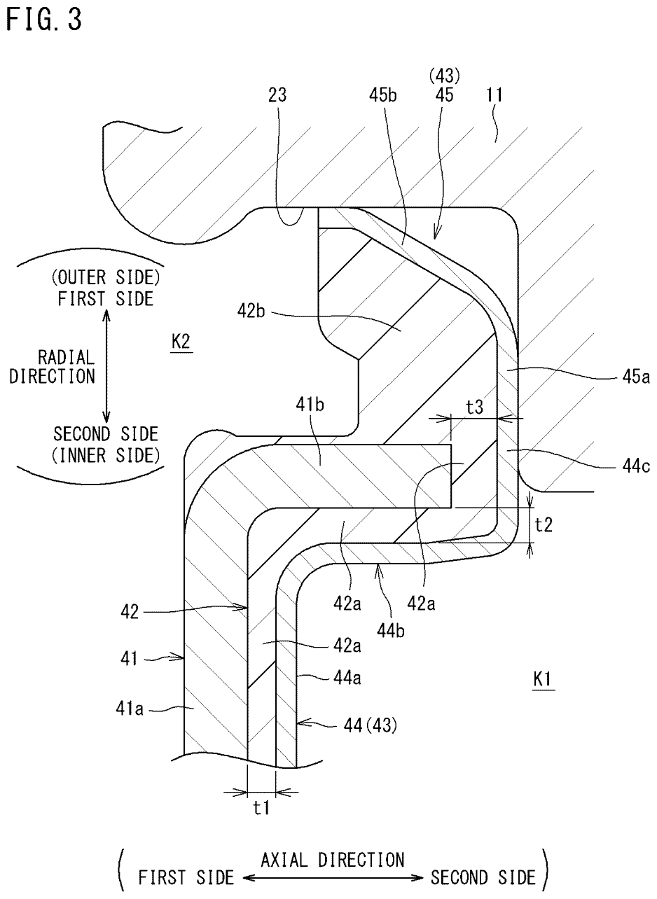

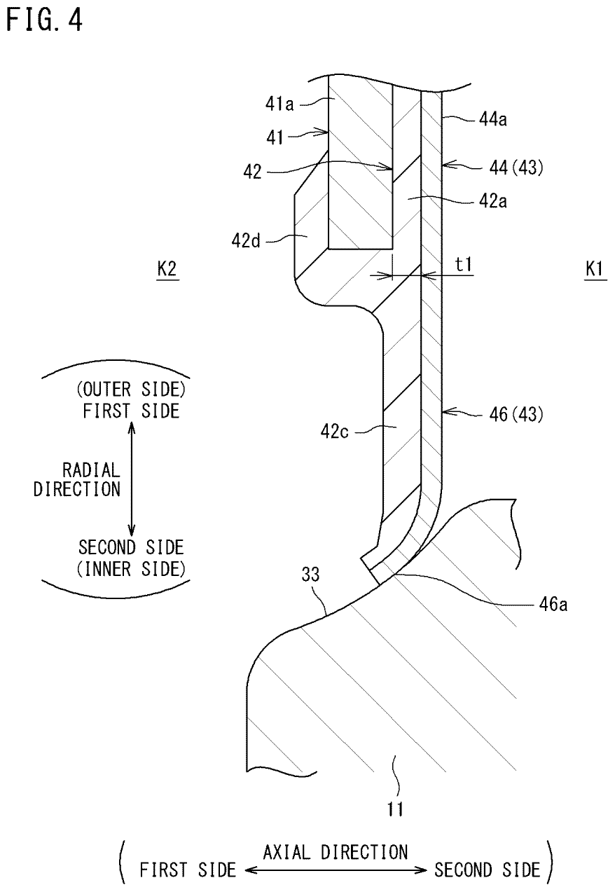

FIG. 2 is an enlarged cross-sectional view of the sliding member. FIG. 3 is an enlarged cross-sectional view of a radially outer portion of the sliding member of FIG. 2. FIG. 4 is an enlarged cross-sectional view of a radially inner portion of the sliding member of FIG. 2.

In description below, a specific structure of the sliding member 15 disposed on the axially first side (the left side in FIG. 1) of the rolling bearing 10 will be described. Therefore, in the description of the sliding member 15, the axially first side can be rephrased as a bearing external space K2 side, and the axially second side can be rephrased as a bearing internal space K1 side. The sliding member 15 disposed on the axially second side (the right side in FIG. 1) of the rolling bearing 10 is the same component as the sliding member 15 disposed on the first side, but is disposed to be inverted in the axial direction.

As illustrated in FIG. 2 to FIG. 4, the sliding member 15 includes a metal ring 41, rubber 42, and the sheet 43. The metal ring 41, the rubber 42, and the sheet 43 are all annular. The metal ring 41 and the rubber 42, and the rubber 42 and the sheet 43 are bonded to each other, and are integrated as a whole.

The metal ring 41 is formed of a metal such as a galvanized steel plate or stainless steel. The metal ring 41 is formed by processing a plate material. The metal ring 41 includes an annular portion 41a formed in an annular shape and a cylindrical portion 41b formed in a cylindrical shape. The annular portion 41a is disposed perpendicular to the axial direction. The cylindrical portion 41b is disposed in parallel with the axial direction. The cylindrical portion 41b is disposed at a radially outer end portion of the annular portion 41a. The cylindrical portion 41b extends from the radially outer end portion of the annular portion 41a to the axially second side (the bearing internal space K1 side). The annular portion 41a and the cylindrical portion 41b of the metal ring 41 are formed by plastically processing the plate material into a substantially L-shaped cross section.

The rubber 42 has a conductivity. Specifically, the rubber 42 is manufactured, for example, by blending a material having a conductivity into synthetic rubber. The material having a conductivity is carbon black, metal powder, or the like. A specific structure of the rubber 42 will be described later together with a structure of the sheet 43.

The sheet 43 is made of a nonwoven fabric or a woven fabric made of fibers having a conductivity. In the present embodiment, carbon fibers are used as the conductive fibers in the sheet 43. However, as the conductive fibers, fibers formed of another material, for example, a metal having a conductivity such as copper or nickel may be used. An electric resistance of the sheet 43 is lower than an electric resistance of the rubber 42. Therefore, the sheet 43 has a higher conductivity than the rubber 42.

In the present embodiment, the sheet 43 further contains a synthetic resin as a binder. The binder is fixed to a surface of a part of the conductive fibers contained in the sheet 43. The sheet 43 of the present embodiment is a nonwoven fabric or a woven fabric made of the conductive fibers with the binder fixed.

The sheet 43 integrally has an intermediate portion 44, a fixed portion 45, and a sliding portion 46. The fixed portion 45 is a portion disposed on the radially outer side (on the radially first side) with respect to the metal ring 41. The sliding portion 46 is a portion disposed on the radially inner side (the radially second side) with respect to the metal ring 41. The intermediate portion 44 is a portion disposed between the fixed portion 45 and the sliding portion 46.

The intermediate portion 44 of the sheet 43 has a first portion 44a, a second portion 44b, and a third portion 44c. The first portion 44a extends in the radial direction. As illustrated in FIG. 3 and FIG. 4, the first portion 44a is disposed at an interval t1 on the axially second side (the bearing internal space K1 side) of the annular portion 41a of the metal ring 41.

The second portion 44b is bent from an end portion on the radially outer side of the first portion 44a to the axially second side, and extends in the axial direction. Therefore, the second portion 44b is formed in a cylindrical shape. As illustrated in FIG. 3, the second portion 44b is disposed at an interval t2 on the radially inner side of the cylindrical portion 41b of the metal ring 41.

The third portion 44c is bent to the radially outer side from an end portion on the axially second side of the second portion 44b, and extends in the radial direction. As illustrated in FIG. 3, the third portion 44c is disposed at an interval t3 on the axially second side of the cylindrical portion 41b of the metal ring 41. Therefore, the intermediate portion 44 of the sheet 43, and the metal ring 41 are disposed at the intervals t1, t2, t3 in the entire radial direction.

The fixed portion 45 of the sheet 43 is formed continuously with the third portion 44c of the intermediate portion 44. As illustrated in FIG. 3, the fixed portion 45 has a fourth portion 45a and a fifth portion 45b. The fourth portion 45a continuously extends in the radial direction as it is from a radially outer end portion of the third portion 44c of the intermediate portion 44. The fifth portion 45b extends from a radially outer end portion of the fourth portion 45a while inclining toward the axially first side and the radially outer side. A distal end of the fifth portion 45b constitutes a radially outer end of the sheet 43. The distal end of the fifth portion 45b is in direct contact with the annular groove 23 of the outer ring 11. In the present embodiment, the fourth portion 45a of the fixed portion 45 is also in direct contact with the annular groove 23. A part of the third portion 44c of the intermediate portion 44 is also in direct contact with the annular groove 23.

As illustrated in FIG. 2 and FIG. 4, the sliding portion 46 of the sheet 43 is formed continuously with the first portion 44a which is the intermediate portion 44. In the present embodiment, a portion of the sheet 43 disposed on the radially inner side with respect to a radially inner end portion of the metal ring 41 is the sliding portion 46. The sliding portion 46 linearly extends to the radially inner side as it is from the first portion 44a of the intermediate portion 44. Therefore, the first portion 44a of the intermediate portion 44, and the sliding portion 46 are formed in an annular shape perpendicular to the axial direction as a whole. A radially inner end portion 46a of the sliding portion 46 is in direct contact with the sliding member contact surface 33 of the inner ring 12. The radially inner end portion 46a of the sliding portion 46 is bent toward the axially first side by coming into contact with the sliding member contact surface 33.

As illustrated in FIG. 2, the rubber 42 is bonded to the sheet 43 and the metal ring 41. The rubber 42 is provided on the entire axially first side (the bearing outer space K2 side) of the sheet 43. The rubber 42 has a first portion 42a, a second portion 42b, a third portion 42c, and a fourth portion 42d.

The first portion 42a of the rubber 42 is a portion disposed in the intervals t1, t2, t3 formed between the metal ring 41 and the sheet 43. The first portion 42a of the rubber 42 holds the intervals t1, t2, t3 between the metal ring 41 and the sheet 43 so that the metal ring 41 and the sheet 43 are not directly bonded.

The second portion 42b of the rubber 42 is continuously formed on the radially outer side of the first portion 42a. The second portion 42b is disposed in a region surrounded by the fixed portion 45 of the sheet 43 and the cylindrical portion 41b of the metal ring 41. The second portion 42b of the rubber 42 elastically supports the fifth portion 45b of the sheet 43 from the radially inner side. The cylindrical portion 41b of the metal ring 41 supports the second portion 42b of the rubber 42 from the radially inner side. Therefore, the fixed portion (a radially outer end portion) 45 of the sheet 43 is pressed against the annular groove 23 of the outer ring 11 by the elasticity of the second portion 42b of the rubber 42 supported by the cylindrical portion 41b of the metal ring 41, and is reliably brought into contact with the annular groove 23.

As illustrated in FIG. 4, the third portion 42c of the rubber 42 extends to the radially inner side from a radially inner end portion of the first portion 42a of the rubber 42. The third portion 42c is provided with a substantially constant thickness along a side surface on the axially first side of the sliding portion 46 of the sheet 43. The third portion 42c is formed in an annular shape perpendicular to the axial direction. When the radially inner end portion 46a of the sliding portion 46 of the sheet 43 comes into contact with the sliding member contact surface 33, and bends, the third portion 42c of the rubber 42 is elastically deformed and bent to the axially first side together with the sliding portion 46.

The fourth portion 42d of the rubber 42 is disposed on a side surface on the axially first side of the metal ring 41 beyond a radially inner end portion of the metal ring 41 from a radially outer end portion of the third portion 42c. Therefore, the fourth portion 42d is formed to have a substantially L-shaped cross-sectional shape, covers a radially inner end surface of the annular portion 41a and the side surface on the axially second side, and is bonded to these surfaces. The fourth portion 42d of the rubber 42 serves to firmly bond the rubber 42 and the metal ring 41, and suppresses peeling of the rubber 42 from the metal ring 41.

Since the rubber 42 has a higher rigidity than the sheet 43, a shape of the sheet 43 is held by the rubber 42. A shape of the intermediate portion 44 of the sheet 43 is also held by the metal ring 41.

The sheet 43 is formed of the nonwoven fabric or the woven fabric formed of the conductive fibers. The sheet 43 includes a gap therein in a state of a material before the sliding member 15 is manufactured. After the manufacturing of the sliding member 15, the rubber 42 is also present in the gap of the sheet 43. As described later, the sliding member 15 is manufactured by molding a rubber material constituting the rubber 42 into a predetermined shape while vulcanizing the rubber material in a state where the metal ring 41 and the sheet 43 are inserted in a die, and bonding the rubber material to the metal ring 41 and the sheet 43. Hereinafter, this manufacturing process is also referred to as “vulcanization adhesion”. At the time of this vulcanization adhesion, the rubber 42 enters the gap of the sheet 43. At the time of vulcanization adhesion, the rubber 42 is easily bonded to the binder.

The fixed portion 45 of the sheet 43 is exposed on the surface of the sliding member 15 and contacts the annular groove 23 of the outer ring 11. Further, the sliding portion 46 of the sheet 43 is exposed on the surface of the sliding member 15 and comes into contact with the sliding member contact surface 33 of the inner ring 12. Since the plurality of conductive fibers constituting the sheet 43 are in contact with each other, the sheet 43 has a conductivity from the fixed portion 45 to the sliding portion 46 due to contact between the conductive fibers. Since the sheet 43 is in contact with the outer ring 11 and the inner ring 12, the outer ring 11 and the inner ring 12 are electrically connected via the sheet 43. In addition, the metal ring 41 and the rubber 42 each having a conductivity are in contact with the sheet 43. The outer ring 11 and the inner ring 12 are also electrically connected via the metal ring 41 and the rubber 42 each having a conductivity in addition to the sheet 43.

Therefore, the sliding member 15 of the present embodiment can release electric charge from one of the fixed portion 45 and the sliding portion 46 to the other. In addition, the sliding member 15 of the present embodiment can release electric charge from one of a member to which the fixed portion 45 is fixed and a member on which the sliding portion 46 slides to the other. The rolling bearing 10 of the present embodiment can release electric charge from one of the outer ring 11 and the inner ring 12 to the other via the sliding members 15, and can suppress electrolytic corrosion of the balls 13, and the raceway 21 of the outer ring and the raceway 31 of the inner ring on which the balls 13 roll.

As illustrated in FIG. 2, the sheet 43 is disposed on the axially most second side (the bearing internal space K1 side) of the sliding member 15. On the other hand, the sliding member contact surface 33 formed on the inner ring 12 is a surface facing the axially first side (the bearing external space K2 side). Therefore, it is easy to bring the sliding portion 46 of the sheet 43 into contact with the sliding member contact surface 33. However, when the sliding member contact surface 33 is a surface facing the axially second side, the sliding member 15 may be formed such that the sheet 43 is located on the axially most first side of the sliding member 15.

### Method for Manufacturing Sliding Member

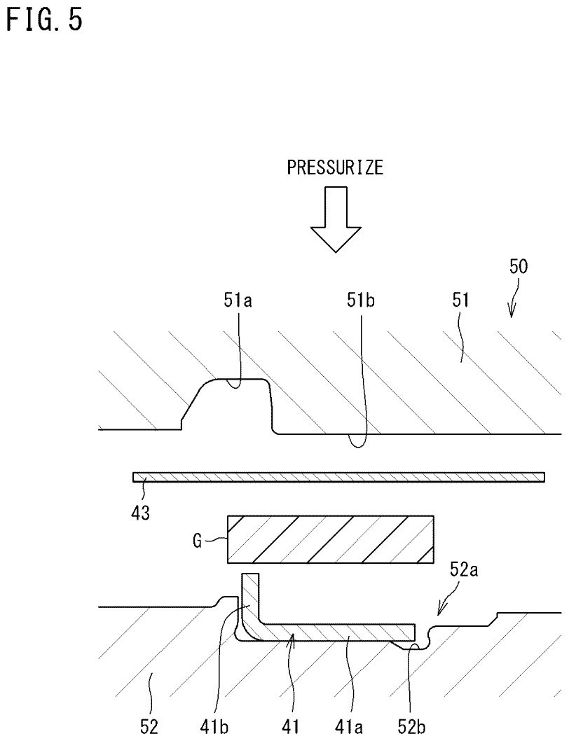

FIG. 5 is a cross-sectional view illustrating a part of a molding die of the sliding member.

The sliding member 15 is manufactured by compression molding (pressure molding) using a die. A molding die 50 of the sliding member 15 includes an upper die 51 and a lower die 52. The upper die 51 includes a cavity 51a. The lower die 52 includes cavities 52a, 52b. The cavity 52b is formed to be further dug down from a bottom surface of the cavity 52a.

An adhesive is applied to a surface of the metal ring 41. For example, the metal ring 41 is immersed in an adhesive to apply the adhesive to the surface.

The metal ring 41, the sheet 43, and an unvulcanized rubber material G are disposed between the upper die 51 and the lower die 52 in a state where the upper die 51 and the lower die 52 are separated and the die 50 is opened.

The cavity 51a of the upper die 51 molds the second portion 42b and a part of the first portion 42a (around the cylindrical portion 41b of the metal ring 41) of the rubber 42 illustrated in FIG. 2. The second portion 44b of the intermediate portion 44 of the sheet 43 and the fixed portion 45 enter the cavity 51a, and the sheet 43 is molded into a shape along an inner surface of the cavity 51a.

The cavity 52a of the lower die 52 molds a part of the first portion 42a (a portion excluding a periphery of the cylindrical portion 41b of the metal ring 41) and the third portion 42c in the rubber 42 illustrated in FIG. 2. A part of the first portion 44a in the intermediate portion 44 of the sheet 43 and the sliding portion 46 enter the cavity 52a and are formed into a flat shape (see FIG. 5) along a lower surface 51b of the upper die 51. The cavity 52b of the lower die 52 molds the fourth portion 42d of the rubber 42 illustrated in FIG. 2.

The sliding member 15 is manufactured by closing the upper die 51 and the lower die 52 in a state where the metal ring 41, the sheet 43, and the unvulcanized rubber material G are disposed between the upper die 51 and the lower die 52, and pressurizing and heating them. The pressurized unvulcanized rubber material G flows into the die. The unvulcanized rubber material G is filled in the cavities 51a, 52a, 52b of the upper die 51 and the lower die 52. In addition, the unvulcanized rubber material G also enters the gap of the sheet 43. By heating in this state, the adhesive is cured, and the unvulcanized rubber material G becomes the rubber 42. When the adhesive is cured and the unvulcanized rubber material G becomes the vulcanized rubber 42, the metal ring 41, the sheet 43, and the rubber 42 are integrated. The integrated member becomes the sliding member 15 by cutting an unnecessary portion.

In this manner, by impregnating the sheet 43 with the unvulcanized rubber material G and vulcanizing the resultant, a rigidity of the sheet 43 is enhanced, and the sheet 43 and the rubber 42 are integrated.

### Other Embodiments

The rolling bearing 10 of the above embodiment is a case where the outer ring 11 is a fixed ring, and the inner ring 12 is a rotating ring. On the other hand, in the present invention, the outer ring 11 may be a rotating ring, and the inner ring 12 may be a fixed ring.

The sliding member 15 of the above embodiment is fixed to the outer ring 11 that is the first member, and slidably contacts the inner ring 12 that is the second member. On the other hand, the present invention may be fixed to the inner ring 12 that is the first member, and slidably contact the outer ring 11 that is the second member.

In the sliding member 15 of the above embodiment, the synthetic resin as the binder is fixed to the conductive fibers constituting the sheet 43. On the other hand, in the sheet of the present invention, the conductive fibers constituting the sheet may not contain the synthetic resin as the binder.

The sliding member 15 of the above embodiment is used for the rolling bearing 10. However, the sliding member 15 of the present invention only needs to be used in a device that is fixed to one member of two relatively moving members and slidably contacts the other member.

In the above embodiment, the case where the rolling bearing 10 is a deep groove ball bearing has been described. However, in the present invention, the rolling bearing 10 may be an angular ball bearing, a roller bearing in which rolling elements are rollers, or the like.

The above embodiments should be considered to be illustrative in all respects, and not to be restrictive. The scope of the present invention is defined by the claims rather than the above embodiments, and includes all modifications within the scope equivalent to the constitutions described in the claims.

### REFERENCE SIGNS LIST

10 rolling bearing
11 outer ring
12 inner ring
13 rolling element
15 sliding member
21 outer ring raceway
31 inner ring raceway
41 metal ring
42 rubber
42a first portion
42b second portion
42c third portion
42d fourth portion
43 sheet
44 intermediate portion
45 fixed portion
46 sliding portion

1. A sliding member comprising:
a sheet that is a nonwoven fabric or a woven fabric formed of conductive fibers;
a metal ring; and
a rubber,
wherein the sheet integrally has:
a fixed portion that is fixed in a state of being in contact with a first member including a steel material on a first side in a radial direction of the metal ring;
a sliding portion slidably contacting a second member including a steel material on a second side in the radial direction; and
an intermediate portion positioned between the fixed portion and the sliding portion,
the metal ring is disposed at an interval on a first side in an axial direction with respect to the sheet,
the rubber has a first portion disposed in the interval,
the rubber further includes a second portion disposed on the first side in the radial direction with respect to the first portion and a third portion disposed on the second side in the radial direction with respect to the first portion, and
the first portion, the second portion, and the third portion are bonded to an entirety of the first side in the axial direction of the sheet.

2. (canceled)

3. The sliding member according to claim 1, wherein the rubber has a fourth portion disposed beyond an end portion in the radial direction of the metal ring on the first side in the axial direction with respect to the metal ring.

4. A rolling bearing comprising:
an inner ring having an inner ring raceway;
an outer ring having an outer ring raceway disposed on a radially outer side of the inner ring raceway;
a plurality of rolling elements rotatably disposed between the inner ring raceway and the outer ring raceway; and
the sliding member according to claim 1, the sliding member being disposed between an end portion in the axial direction of the inner ring and an end portion in the axial direction of the outer ring in the radial direction,
wherein one of the inner ring and the outer ring is the first member, and
the other of the inner ring and the outer ring is the second member.

5. The rolling bearing according to claim 4, wherein the sheet of the sliding member is disposed closer to the rolling elements than the metal ring and the rubber in the axial direction.
